(19) United States
(12) Patent Application Publication
(10) Pub. No.: US 2017/0249061 A1
(43) Pub. Date: Aug. 31, 2017

(54) Method and Apparatus for Providing User Interfaces with Computerized Systems and Interacting with a Virtual Environment

(71) Applicant: Lampix, New York, NY (US)

(72) Inventors: George Alex Popescu, New York, NY (US); Mihai Dumitrescu, New York, NY (US)

(21) Appl. No.: 15/443,103

(22) Filed: Feb. 27, 2017

Related U.S. Application Data
(60) Provisional application No. 62/301,110, filed on Feb. 29, 2016.

(51) Int. Cl. G06F 3/0482; G06F 3/00; G06T 19/00; G06F 3/01

(52) U.S. Cl. CPC G06F 3/0482; G06F 3/017; G06F 3/005; G06T 19/006; H05B 37/0209

(57) ABSTRACT

The present invention is a method and apparatus for providing user interfaces for computerized systems.

### RELATED APPLICATIONS

This application is a continuation of and claims priority from U.S. Provisional Patent Application 62/301,110.

### FIELD OF THE INVENTION

The present invention relates to the fields of augmented reality and user interfaces for computerized systems. Augmented reality technologies allow virtual imagery to be presented in real-world physical environments. The present invention allows users to interact with these virtual images to perform various functions,

### BACKGROUND OF THE INVENTION

The personal computer has been a huge boon for productivity, adapting to the needs of a wide variety of personal and professional endeavors. Despite the ongoing evolution of personal computing, one divide is persistent. Physical documents and digital files interact in limited ways. People need to interrupt their workflow to print files or scan documents, and changes in one realm are not reflected across mediums. Many types of user interface devices and methods are available, including keyboard, mouse, joystick, and touch screen, but computers and digital information have limited interaction with a user's physical workspace and documents.

Recently, interactive touchscreens have been used for presenting information on flat surfaces. For example, an image may be displayed on a touchscreen, and a user may interact with the image by touching the touchscreen, causing the image to change. However, in order to interact with the image displayed on the touchscreen, the user must actually come in contact with the touchscreen. By requiring contact with a touchscreen to provide interactivity, a large number of potential users are not engaged by current interactive displays. Since only one user may interact with a touchscreen at a time, additional users are also excluded. Moreover, interactivity is limited by the size and proximity of the touchscreen.

Other systems or methods for interacting with virtual environment rely on image processing rather than tactile interfaces. Image processing is used in many areas of analysis, education, commerce, and entertainment. One aspect of image processing includes human-computer interaction by motion capture or detecting human forms and movements to al low interaction with images through motion capture techniques. Applications of such processing can use efficient or entertaining ways of interacting with images to define digital shapes or other data, animate objects, create expressive forms, etc.

With motion capture techniques, mathematical descriptions of a human performer's movements are input to a computer or other processing system. Natural body movements can be used as inputs to the computer to study athletic movement, capture data for later playback or simulation, enhance analysis for medical purposes, etc.

Although motion capture provides benefits and advantages, motion capture techniques tend to be complex. Some techniques require the human actor to wear special suits with high-visibility points at several locations. Other approaches use radio-frequency or other types of emitters, multiple sensors and detectors, blue-screens, extensive post-processing, etc. Techniques that rely on simple visible-light image capture are usually not accurate enough to provide well-defined and precise motion capture.

More recently, patterned illumination has been used to discern physical characteristics like an object's size, shape, orientation, or movement. These systems generally project infrared light, or other nonvisible spectra, which is then captured by visual sensor sensitive to the projected light. As an example, U.S. Pat. No. 8,035,624, whose disclosure is incorporated herein by reference, describes a computer vision based touch screen, in which an illuminator illuminates an object near the front side of a screen, a camera detects interaction of an illuminated object with an image separately projected onto the screen by a projector, and a computer system directs the projector to change the image in response to the interaction.

Other similar systems include an interactive video display system, U.S. Pat. No. 7,834,846, in which a display screen displays a visual image, and a camera captures 3D information regarding an object in an interactive area located in front of the display screen. A computer system directs the display screen to change the visual image in response to changes in the object.

Yet another method is the Three-Dimensional User Interface Session Control, U.S. Pat. No. 9,035,876, in which a computer executes a non-tactile three dimensional (3D) user interface, a set of multiple 3D coordinates representing a gesture by a hand positioned within a field of view of a sensing device coupled to the computer, the gesture including a first motion in a first direction along a selected axis in space, followed by a second motion in a second direction, opposite to the first direction, along the selected axis. Upon detecting completion of the gesture, the non-tactile 3D user interface is transitioned from a first state to a second state.

### SUMMARY OF THE INVENTION

The invention is a device that delivers functionality of a personal computer (“PC”) to the physical desktop. The device provides seamless integration between paper and digital documents, creating an augmented office space beyond the limited screens of current devices. The invention makes an entire desk or office space interactive, allowing for greater versatility in user-computer interactions. The invention provides these benefits without adding additional obtrusive hardware to the office space. Contained within a lighting fixture or other office fixture, the invention reduces clutter beyond even the slimmest laptops or tablets.

### BRIEF DESCRIPTION OF THE DRAWINGS

FIG. 1 shows a side view of some components of an embodiment of the invention

FIG. 2 shows an alternative view of some components of an embodiment of the invention.

FIG. 3 shows a bottom view of some components of an embodiment of the invention.

FIG. 4 shows an embodiment of the invention displaying a traditional computer interface.

FIG. 5 shows an embodiment of the invention projecting menu items in proximity to a recognized object.

FIG. 6 shows a user interacting with menu items that control the lamp in an embodiment of the invention.

FIG. 7 shows an embodiment of the invention recognizing and highlighting certain words on a physical document.

### DETAILED DESCRIPTION OF THE INVENTION

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “projecting” or “detecting” or “changing” or “illuminating” or “correcting” or “eliminating” or the like, refer to the action and processes of an electronic system (e.g., an interactive video system), or similar electronic computing device, that manipulates and transforms data represented as physical (electronic) quantities within the electronic device's registers and memories into other data similarly represented as physical quantities within the electronic device memories or registers, or other such information storage, transmission, or display devices.

Some described embodiments may use a video camera which produces a three-dimensional (3D) image of the objects it views. Time-of-flight cameras have this property. Other devices for acquiring depth information (e.g. 3D image data) include but are not limited to a camera paired with structured light, stereo cameras that utilize stereopsis algorithms to generate a depth map, ultrasonic transducer arrays, laser scanners, and time-of-flight cameras. Typically, these devices produce a depth map, which is a two-dimensional (2D) array of values that correspond to the image seen from the camera's perspective. Each pixel value corresponds to the distance between the camera and the nearest object that occupies that pixel from the camera's perspective. Moreover, while embodiments of the present invention may include at least one time-of-flight camera, it should be appreciated that the present invention may be implemented using any camera or combination of cameras that are operable to determine three-dimensional information of the imaged object, such as laser scanners and stereo cameras. In an embodiment, a high focal length camera may be utilized to capture high-resolution images of objects.

The invention uses one or more visual sensors to monitor a workspace. In one embodiment, a visual sensor is a camera that is operable to capture three-dimensional information about the object. In one embodiment, the camera is a time-of-flight camera, a range imaging camera that resolves distance based on the speed of light. In one embodiment, the object is a user. In one embodiment, the distance information is used for person tracking. In one embodiment, the distance information is used for feature tracking. Feature tracking would be useful in creating a digital representation of a 3D object and/or distinguishing between different 3D objects.

A workspace may be a desk, chalkboard, whiteboard, drafting table, bookshelf, pantry, cash register, checkout area, or other physical space in which a user desires computer functionality. In monitoring the workspace, the device recognizes physical objects for example, documents or books and presents options for various functions performed by a computer on the object. To present options, the device may utilize one or more projectors. The projector may create an image on a surface of the workspace representing various options as menu items by words or other recognizable symbols. Options may also be presented on another device accessible to the users and linked with the present invention for example, a smartphone, tablet, computer, touchscreen monitor, or other input device.

Displayed images or items can include objects, patterns, shapes, or any visual pattern, effect, etc. Aspects of the invention can be used for applications such as interactive lighting effects for people at clubs or events, interactive advertising displays, characters and virtual objects that react to the movements of passers-by, interactive ambient lighting for public spaces such as restaurants, shopping malls, sports venues, retail stores, lobbies and parks, video game systems, and interactive informational displays. Other applications are possible and are within the scope of the invention.

In general, any type of display device can be used in conjunction with the present invention. For example, although video devices have been described in the various embodiments and configurations, other types of visual presentation devices can be used. A light-emitting diode (LED) array, organic LED (OLED), light-emitting polymer (LEP), electromagnetic, cathode ray, plasma, mechanical or other display system can be employed. A plurality of light-emitting mechanisms may be employed. In an embodiment one or more of the light emitting elements may emit various illumination patterns or sequences to aide in recognition of objects. A variety of structured lighting modules are known in the field.

Virtual reality, three-dimensional, or other types of displays can be employed. For example, a user can wear imaging goggles or a hood so that they are immersed within a generated surrounding. In this approach, the generated display can align with the user's perception of their surroundings to create an augmented, or enhanced, reality. One embodiment may allow a user to interact with an image of a character. The character can be computer generated, played by a human actor, etc. The character can react to the user's actions and body position. Interactions can include speech, co-manipulation of objects, etc.

Multiple systems can be interconnected via a digital network. For example, Ethernet, Universal Serial Bus (USB), IEEE 1394 (Firewire), etc., can be used. Wireless communication links, such as defined by 802.11b, etc., can be employed. By using multiple systems, users in different geographic locations can cooperate, compete, or otherwise interact with each other through generated images. Images generated by two or more systems can be “tiled” together, or otherwise combined to produce conglomerate displays.

Other types of illumination, as opposed to light, can be used. For example, radar signals, microwave or other electromagnetic waves can be used to advantage in situations where an object to detect (e.g., a metal object) is highly reflective of such waves. It is possible to adapt aspects of the system to other forms of detection, such as by using acoustic waves in air or water.

Although computer systems have been described to receive and process the object image signals and to generate display signals, any other type of processing system can be used. For example, a processing system that does not use a general-purpose computer can be employed. Processing systems using designs based upon custom or semi-custom circuitry or chips, application specific integrated circuits (ASICs), field-programmable gate arrays (FPGAs), multiprocessor, asynchronous or any type of architecture design or methodology can be suitable for use with the present invention.

To illustrate, if the user placed a business card on her desk, for instance, the device would recognize the business card and present the user with options germane to the contact information contained in the business card such as save, email, call, schedule a meeting or set a reminder. Save would use text recognition to create a new contact in the appropriate software containing the information from the business card. In another embodiment, the device may also recognize when multiple similar documents are present—for example, ten business cards and present options to perform batch functions on the set of similar documents, for example, save all.

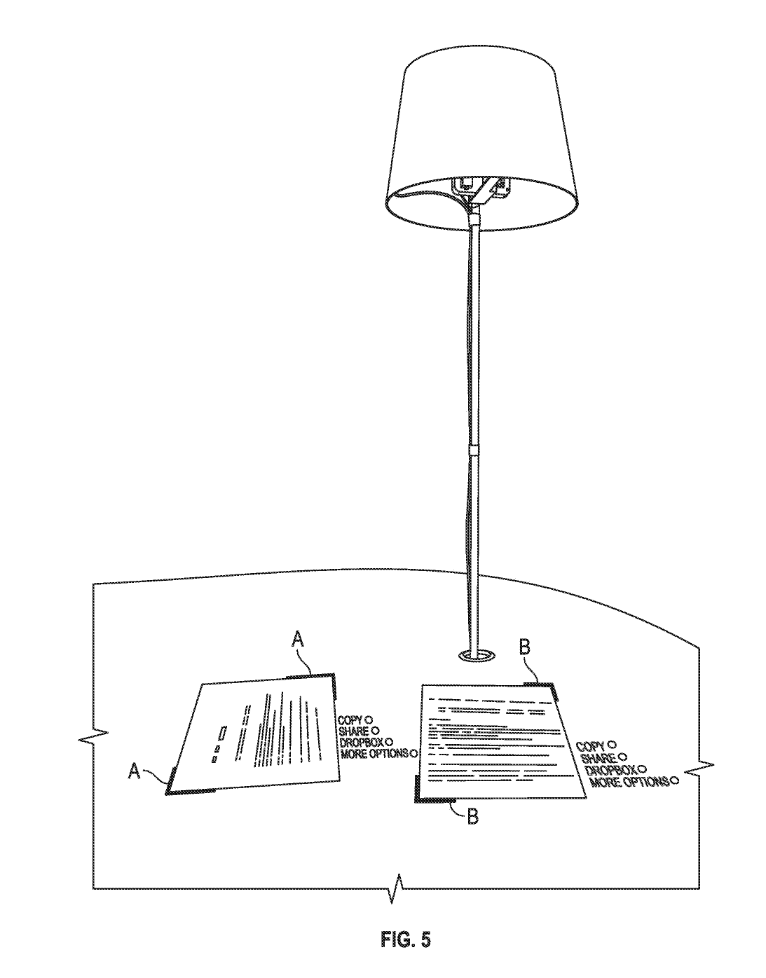

In one embodiment, the device presents options by projecting menu items in proximity to the recognized object as shown in FIG. 5. The device recognizes documents in real time,such that moving a document will cause the associated menu items to move with it. The device also tracks and distinguishes multiple documents. As shown in FIG. 5, the projected pairs of brackets A and B correspond to distinct documents, each of which has its own associated menu of options.

To perform a function, the user touches a menu item. The device recognizes when the users hand engages with a menu item and performs the function associated with the selected menu item. A possible function includes uploading an image of the document or object to Dropbox. When the user touches the “Dropbox” button, as seen in FIG. 5, the device will take a picture of the document or object and upload that picture to the user's Dropbox account. It will be understood that Dropbox is only an example of the many available services for storing, transmitting, or sharing digital files, which also include Box, Google Drive, Microsoft OneDrive, and Amazon Cloud Drive, for example.

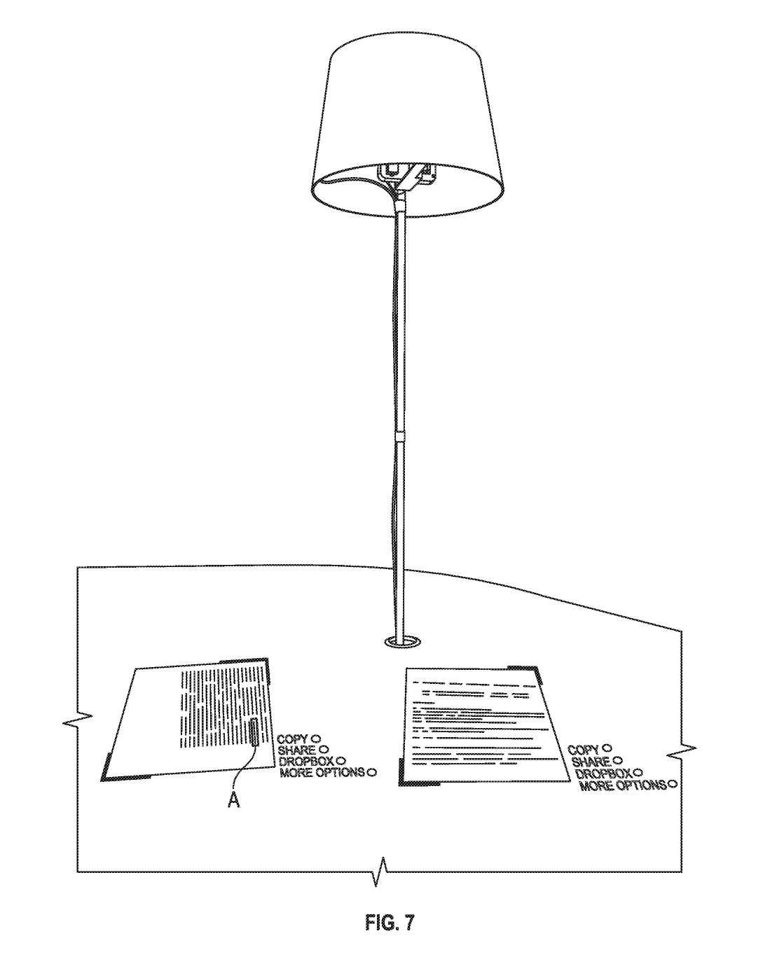

In one embodiment, the invention can recognize text and highlight words on a physical document as shown by A on FIG. 7. For example, a user reading a lease may want to review each instance of the term landlord. The device would find each time the term “landlord” occurs on the page and highlight each instance using the projector. In another exemplary embodiment, the device would have access to a digital version of the document and would display page numbers of other instances of the search term—for example, “landlord”—in proximity to the hard copy document for ease of reference by the user. In yet another embodiment, the device could display an alternate version of the document in proximity to the hard copy version for the user to reference while also highlighting changes in the hard copy document, the digital version, or both.

The device may also recognize markings by the user on a hard copy document and interpret those markings to make changes in the digital version of the document. Such markings could include symbols common in text editing, symbols programmed by the user, or symbols created for the particular program the user is interacting with. For example, a graphic designer may use certain symbols to be translated into preselected design elements for a digital rendering.

Another exemplary function is sharing. When the user touches the “Share” button, the device will take an image or video of the document or object and share the image or video via a selected service by, for example, attaching the image to an email or other message service, or posting the image to Facebook, Twitter, a blog, or other social media service. The device may also incorporate sharing features without the use of third-party services.

In another embodiment, the invention can provide an interactive workspace between two or more users, allowing them to collaborate on the same document by representing the input from one user on other workspaces. This functionality can allow for interactive presentations, teaching, design, or development. For example, a student practicing handwriting could follow a tutor's guide as pen strokes are transmitted in real time between the two devices. Or two artists could sketch on a shared document simultaneously. An embodiment may utilize paper specially prepared by preprinted patterns or other means to facilitate recognition by the device. Throughout the process, the device could maintain a digital record of the users' interactions, maintaining a version history for users to view changes over time or revert to previous versions.

In another embodiment, the device may broadcast live video of a document or workspace. For example, the device would present broadcast or stream as a standalone menu option or as a secondary option under the share menu item. The device would then capture live video of the document or workspace area. The device would also provide options for distributing a link, invitation, or other means for other parties to join and/or view the live stream.

To illustrate further, an accountant may wish to remotely review tax documents with a client. The accountant would initiate the live stream by selecting the appropriate menu option. The device would recognize the associated document and broadcast a video of that document. If the accountant wanted to review multiple documents, she could select the appropriate sharing or streaming option for each relevant document. The device could present options to stream various documents or objects simultaneously or alternately as selected by the user.

In another embodiment, the accountant could “share” or “stream” a portion of her workspace distinct from any individual document or object, but that could include multiple documents or objects. In this case, the user may select “share” or “stream” from a default menu not associated with a particular document. The device would then project a boundary to show the user the area of the workspace captured by the camera for sharing or streaming purposes. The user could adjust the capture area by touching and dragging the projected boundary. The user could also lock the capture area to prevent accidentally adjusting the boundary. To illustrate, a user may be a chef wanting to demonstrate preparing a meal. The device may recognize a cutting board and provide an option to share or stream the cutting board, but the chef may need to demonstrate preparation techniques outside of the cutting board area. The chef could select the share or stream option from the workspace menu and adjust the capture area to incorporate all necessary portions of the workspace. That way, the chef could demonstrate both knife skills for preparing vegetables and techniques for rolling pasta dough in the same capture frame.

The user may also transition from document sharing or streaming to workspace sharing or streaming by adjusting the capture boundary during capture when the capture boundary is not locked.

In one embodiment, the device may recognize that two documents or objects are substantially similar and offer a compare option as a menu item. If the user selected “compare,” the device would use text recognition to scan the documents and then highlight differences between the two. Highlighting would be portrayed by the projector. Alternatively, the device may compare a physical document and a digital version of a substantially similar document. The device would then display differences either on the physical documents as described above or on the digital document or both. The device could display the digital document by projecting an image of the document onto a surface in the workspace or through a smartphone, tablet, laptop, desktop, touchscreen monitor, or other similar apparatus linked to the device.

In one embodiment, the device may check documents for spelling errors and highlight them on either a physical or digital version of the document. The device may also recognize citations or internet links in physical documents and present the referenced material through the projector or other display means previously mentioned. For example, a business card may contain a link to a person's social media accounts (e.g., LinkedIn). In processing the information contained in the business card, for example, the device could incorporate other contact information from online sources, or provide an option to connect with the person via social media accounts.

In one embodiment, the device may recognize an object and provide an option to search a database or the Internet for that object and information related to that object. For example, the device may identify a book by various features including title, author, year of publication, edition, or international standard book number (ISBN). With that information, the device could search the Internet for the book to allow the user to purchase the book, read reviews of the book, see article citing the book, or view works related to the book. For example, if the user was viewing a cookbook, the device could create a shopping list for the user based on ingredients listed in the recipe. The device could also create and transmit an order to a retailer, so that the desired ingredients could be delivered to the user or assembled by the retailer for pickup.

In another embodiment, the device may recognize objects like food items. Many food items have barcodes or other distinguishing characteristics such as shape, color, size, and so on that could be used for identification. Deployed in the kitchen, the device could track a user's grocery purchases to maintain a list of available food. This feature may be accomplished by using the device to scan grocery store receipts. This feature may also be accomplished by using the device of recognize various food items as they are unpacked from grocery bags and place in storage. The device could then also recognize food items as they are used to prepare meals, removing those items from a database of available foods. The device may also access information on freshness and spoilage to remind a user to consume certain food stuffs before they go bad. The device may display recipes based on available food items and other parameters desired by the user. While the user is cooking, the device may provide instructions or other information to assist the user. The device may also create grocery lists for the user based on available food stuffs and past purchasing behaviors. The device may also order certain food items for delivery at the users request.

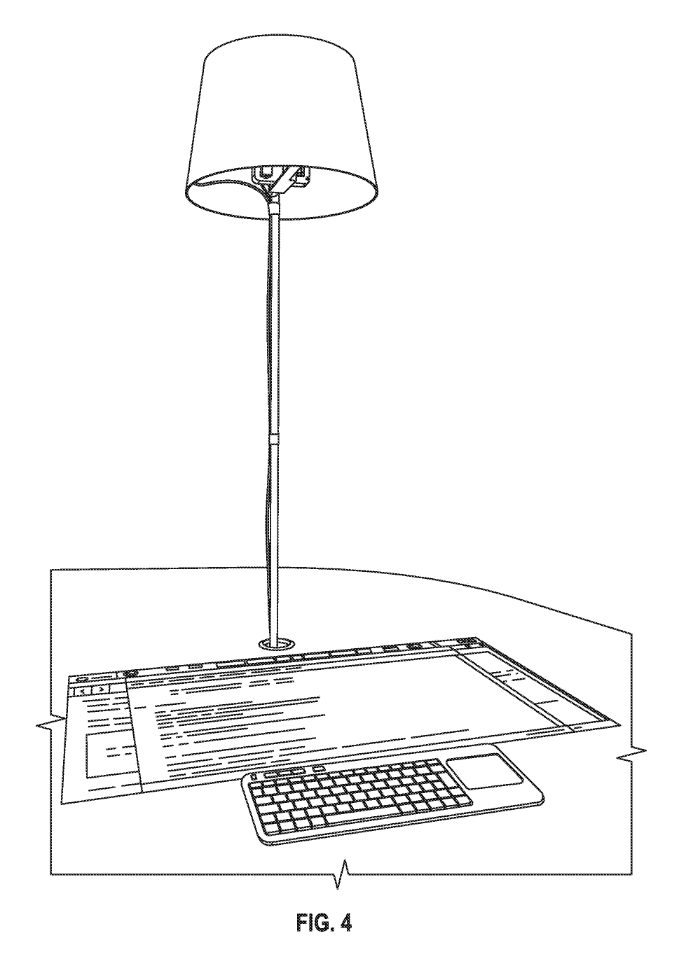

The device may also be employed to improve workspace ergonomics and enabled richer interaction with digital objects. For example, when the device is displaying a traditional computer interface like in FIG. 4, the device may adjust the projected image to create an optimal viewing experience for the user. The device may also display notifications on the user's workspace. This could be accomplished in part by applying known or novel eye-tracking methods. Projection adjustments could include basic modifications like increasing or decreasing text size based on the user's proximity to the projected image. More complex modifications could include changing the perspective of the projected image based on the user's viewing angle and the orientation of the projector and projection surface. Projected images may also be adjusted for other workspace characteristics like the brightness of the surrounding area, the reflectivity of the projection surface, or the color of the projection surface for example, factors which affect the viewability of the projected image. Advanced image manipulation could give the user the impression of one or more 3D objects.

In one embodiment, the device may control its position or orientation through various motors, tracks, pulleys, or other means. In such an embodiment, the device could position self to maintain line of sight with a mobile user or to maintain optimal projected image characteristics depending on the user's position or orientation. The device may also move to interact with objects beyond the user's immediate workspace, for example, searching a bookshelf on the other side of a room. With such mobility, the workspace available to the device could be expanded significantly beyond the capture area of one or more visual sensors.

In another embodiment, the device may also adjust the capture area of one or more visual sensors depending on the functionality desired by the user. For example, if the user wanted the device to search a workspace for an object, the device may adjust the lenses or other mechanisms to capture and analyze a wider viewing area. If the initial broad search was unsuccessful, the device may divide the workspace into smaller areas and adjust lenses or other mechanisms to search those smaller areas at higher resolution. Similarly, the user may want a high resolution image of an object. The device could adjust the capture area of one or more visual sensors to increase or maximize the image resolution.

In one embodiment, the device may recognize characteristics associated with various diseases or ailments. For example, the device may recognize a user's flush complexion and inquire if the user requires aide. As another example, the device my recognize that a user is showing redness or other signs or sunburn and recommend that the user protect herself from further exposure. As another example, the device may cross reference previous images of moles and note changes in a mole's size or appearance to the user or the user's doctor.

In one embodiment, the device may recognize design schematics of a building, for example, either in hard copy or in a digital format using computer-aided design software known in the art. The device may then represent the design and/or building model in 2D and/or 3D format across the workspace using the projector or other display technologies previously enumerated.

In another embodiment, processing can be divided between local and remote computing devices. For example, a server may construct a high-resolution dense 3D model while user interactions are transmitted over a communication network to manipulate the model. Changes to the model are calculated by the service and returned to the user device. Concurrently with this, a low-resolution version of the model is constructed locally at the user device, using less processing power and memory, which is used to render a real-time view of the model for viewing by the user. This enables the user to get visual feedback from the model construction from a local processor, avoiding network latency issues.

In another embodiment, the device could recognize a user's interaction with one or more perceived 2D or 3D objects. The projector or other display technology previously enumerated, could create an image of a 3D building for one or more users, for example. A user could manipulate the digital object by interacting with the borders of the perceived object. The device would recognize when the user's hands, for example, intersect with the perceived edge of a digital object and adjust the image according to the user's interaction. The user may, for example, enlarge the building model by interacting with the model at two points and then dragging those two points farther away from each other. Other interactions could modify the underlying digital object for example, making the model building taller or shorter.

In one embodiment, the device may track different documents that are referenced by the user at the same time. For example, if an accountant reviews a client's tax documents, the device would recognize that the document could be related because of their physical and temporal proximity in the user's workspace. The device could then associate those documents using metadata, tags, or categories. Other indicia of relatedness may also be employed by the device's recognition function—for example, the appearance of similar names or terms. The user may also indicate other types of relatedness depending on the nature of the object.

In one embodiment, the device may employ its recognition function o track the physical location of documents or other objects to help users later find those objects. For example, an accountant may reference a binder containing a client's tax documentation including a W-2 form from a prior year. The device may track characteristics of the document and the binder containing the document as the user places the binder on a bookshelf in the workspace. Later, the accountant may want to reference the document again and could query the device to show the location of the document by interacting with projected menu options or other input device previously enumerated. The device could then highlight the appropriate binder using a projector. The device may also display digital versions of documents contained in a binder for the user to view without having to open the binder. The device may also associate one or more digital objects with a physical object. In such an embodiment, the physical object would act like a digital tag or folder for the associated digital objects. For example, the device may associate the user's preferred newspaper or news channel with a cup of coffee such that when the user sits at a table with a cup of coffee, the device retrieves the news source and displays it for the user. Such digital/physical associations may also be temporally dependent so that the device would not display the morning news if the user had a cup of coffee in the afternoon. The device may also track frequently referenced documents to suggest optimized digital and physical organization schemes based on reference frequency and/or other characteristics.

In an embodiment, the device may display certain features from a digital environment, such as program windows from a classical desk, on to physical objects like a piece of paper to extend the working digital desktop space and enhance interactivity. The device my also associate certain digital objects or documents with not only physical objects but also features of the physical objects. For example, certain drawings, images, notes, or text may be associative elements, enabling the user to recall quickly or more easily those digital and physical objects.

In an embodiment, the device may also utilize a plurality of microphones to detect interaction between the user and various objects. Microphones may also be used to detect the position of various objects.

The device will also allow for interaction by voice command, separate or in conjunction with other input modes. The device will also allow for implementation of additional functionality by developers and users.

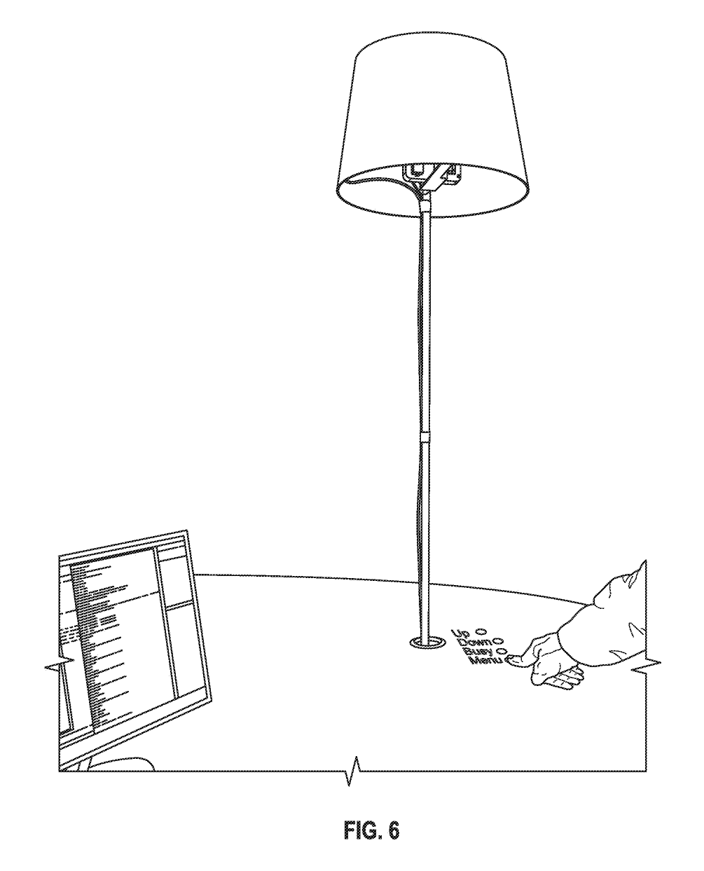

The device has another distinct advantage over computers: it will also function as a working lamp. As shown in FIG. 6, the lamp may be controlled through the default menu items, which include “Up” and “Down” to adjust the brightness of the lamp.

Although the device is presented here as a lamp, it may take other forms or be integrated into other objects. For example, the device could be on or in a car's passenger compartment, a dashboard, an airplane seat, a ceiling, a wall, a helmet, or a necklace or other wearable object.

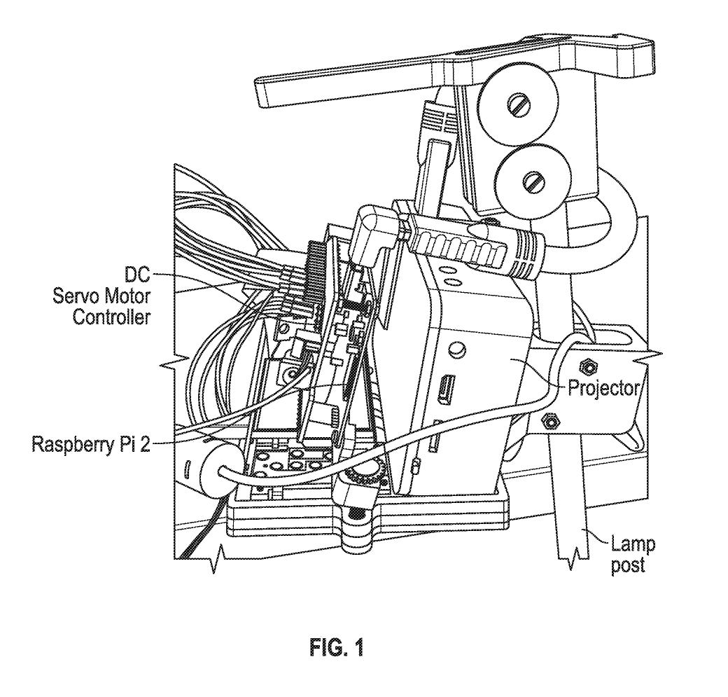

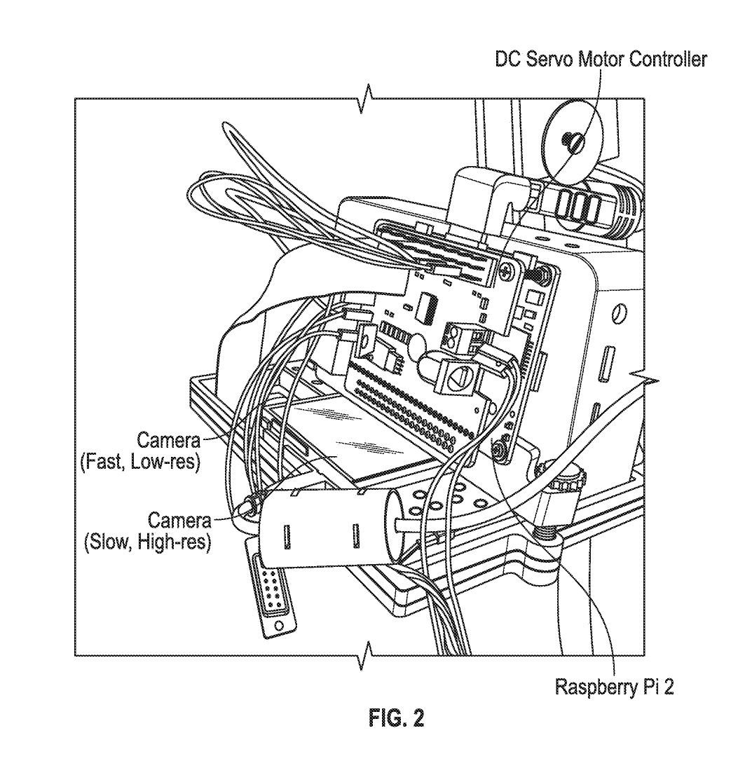

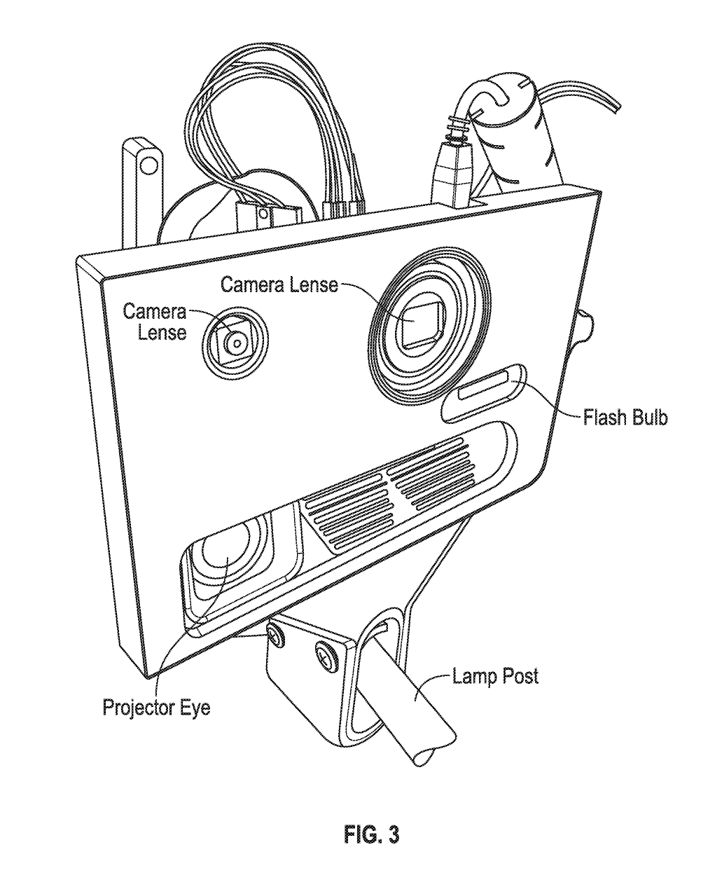

In one embodiment, the device has one or more visual sensors, one or more projectors, one or more audio sensors, a processor, a data storage component, a power supply, a light source, and a light source controller. One possible configuration of the device is shown in FIGS. 1-3.

These interactive display systems can incorporate additional inputs and outputs, including, but not limited to, microphones, touchscreens, keyboards, mice, radio frequency identification (RFID) tags, pressure pads, cellular telephone signals, personal digital assistants (PDAs), and speakers.

These interactive display systems can be tiled together to create a single larger screen or interactive area. Tiled or physically separate screens can also be networked together, allowing actions on one screen to affect the image on another screen.

In an exemplary implementation, the present invention is implemented using a combination of hardware and software in the form of control logic, in either an integrated or a modular manner. Based on the disclosure and teachings provided herein, a person of ordinary skill in the art will know of other ways and/or methods to implement the present invention.

It will be appreciated that the embodiments described above are cited by way of example, that the present invention is not limited to what has been particularly shown and described hereinabove, and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety. The scope of the present invention includes both combinations and subcombinations of the various features described hereinabove, as well as variations and modifications thereof which would occur to persons skilled in the art upon reading the foregoing description and which are not disclosed in the prior art.

1. A computer interface device, comprising:
a computer system comprising at least one memory component and at least one processing component;
at least one visual sensor that receives visual information from a workspace;
at least one illuminating device capable of providing light in the workspace;
at least one display device, wherein the display device is capable of displaying one or more digital objects;
wherein the computer system causes the display device to display a first digital object;
wherein the computer system adjusts the level of light provided in the workspace via the illuminating device based on a user's interaction with the first digital object;
wherein the computer system causes the display device to display a second digital object based on the user's interaction with the first digital object;
wherein the computer system recognizes a first physical object as distinct from the workspace;
wherein the computer system causes the display device to display a first associated digital object in proximity to the first physical object;
wherein the computer system creates a second associated digital object based on information about the first physical object when the user interacts with the first associated digital object; and
wherein the computer system adjusts the first and second associated digital objects when the user interacts with the first physical object.

2. A computer interface device, comprising:
a computer system comprising at least one memory component and at least one processing component;
at least one visual sensor that receives visual information from a workspace;
at least one display device, wherein the display device is capable of displaying one or more digital objects;
wherein the computer system causes the display device to display a first digital object;
wherein the computer system causes the display device to display a second digital object based on the user's interaction with the first digital object;
wherein the computer system recognizes a first physical object as distinct from the workspace;
wherein the computer system causes the display device to display a first associated digital object n proximity to the first physical object;
wherein the computer system creates a second associated digital object based on information about the first physical object when the user interacts with the first associated digital object;
wherein the computer system adjusts the first and second associated digital objects when the user interacts with the first physical object.
